(19) United States
(12) Patent Application Publication
(10) Pub. No.: US 2021/0309132 A1
(43) Pub. Date: Oct. 7, 2021

(54) Vehicular Camp and Method

(71) Applicant: Andras Plank S., San Francisco, CA (US)

(72) Inventor: Andras Plank S, San Francisco, CA (US)

(21) Appl. No.: 16/838,982

(22) Filed: Apr. 2, 2020

(51) Int. Cl. B60N 2/34; B60N 2/12; B60N 2/02; B60R 5/04; B60R 7/04; B60N 3/00

(52) U.S. Cl. CPC B60N 2/34; B60N 2/12; B60N 2/0224; B60R 7/10; B60R 7/04; B60N 2/0248; B60N 3/008; B60R 5/045

(57) ABSTRACT

An in-cabin convertible bed apparatus for vehicles comprising the combined, substantially flat or level surface of a trunk floor, a folded rear seat with a flat back, a parcel shelf to extend the bed surface and may comprise a container used to contain a mattress or elevate the level of the trunk floor providing elevated ergonomics for better quality relaxation or sleep is determined. A method comprises: Optionally folding down a rear seat of a vehicle; folding of a parcel shelf and placing it with one end on about the back of the rear seat of the vehicle and placing the other end on the central console or the central console armrest of the vehicle; partly securing it from sliding or tipping by the back of a seat of a subsequent seat row of the vehicle.

### BACKGROUND

### 1. Technical Field

This invention relates generally to vehicles such as passenger vehicles, coupes, sedans, executive cars, grand tourers, hatchbacks, station wagons, limousines, crossovers, SUV's, minivans and recreational vehicles convertible for camping (hereinafter collectively referred to as “vehicle” or “vehicles” as customary). More particularly, the present invention relates to vehicles with at least one parcel shelf (for e.g., at least one trunk parcel shelf, hereinafter collectively referred to as “parcel shelf” or “parcel shelves” as customary).

### 2. Description of Related Art

Currently, vehicles convertible into camping utilities are becoming ever more popular with electric vehicles allowing their operators to keep HVAC systems on during camping within for a fraction of the cost that of doing the same with internal combustion engine vehicles. These usually comprise of foldable rear seats typically creating a more or less flat or level surface which typically used to support a thin mattress or airbed. These solutions provide limited sleeping comfort when folded down due to the length of the surface, typically requiring the occupant to tuck their knees or sleep diagonally; the occasional difference in the level of the back of the foldable rear seats and the trunk floor as well as other factors such as heat management, cabin containment, occupant safety etc. Furthermore, the limitations in length typically makes it difficult sometimes impossible to sleep more than one occupant comfortably.

### SUMMARY

An apparatus, according to one embodiment, includes a foldable parcel shelf of a vehicle. The parcel shelf comprises of two panels covered connected with at least one hinge. The at least one hinge is preventing the at least two panels from completely folding and effecting them to substantially maintain a significant distance between at least one end of the panels. The system further includes rear seats have substantially flat backs which connect the trunk floor or floor into a substantially flat and/or surface for a level in-cabin convertible bed. The system may further comprise of a central console. The central console provides support to the folded parcel shelf from one end to extending the bed surface. The system further includes a subsequent row of electronically controlled, slidable and/or reclinable seats to secure the parcel. The system further includes a processor, and logic integrated with and/or executable by the processor. The logic is configured to determine the position of the seats of the subsequent row of slidable and/or reclinable seats as well as their tilt angle. The logic is further configured to cause the electronically controlled subsequent row of slidable and/or reclinable seats to slide to a position and/or tilt in an angle to secure the parcel shelf in position.

A method according to one embodiment includes folding each rear seats of a vehicle down. The rear seats have substantially flat backs which connect the trunk floor or floor into a substantially flat and/or level surface, hereinafter referred to as bed surface. The method further includes the folding of a foldable parcel shelf. The parcel shelf includes at least two panels connected with at least one fabric hinge preferably preventing the at least two panels from completely folding and effecting them to substantially maintain a significant distance between at least one end of the panels. The method further includes folding the parcel shelf and placing it by one end on the back of foldable rear seats along the edge of the at least one fabric hinge and on a center console extending the bed surface.

A computer program product according to one embodiment includes a computer readable storage medium having stored thereon computer readable program instructions configured to cause a processor of a computer system to instruct a vehicle to slide and/or tilt one or more seats to secure a folded parcel shelf placed on the back of the headrests of foldable rear seats of a vehicle with one of its end and on a center console of the vehicle on the other.

### BRIEF DESCRIPTION OF THE DRAWINGS

Preferred and alternative examples of the present invention are described in detail below with reference to the following drawings:

FIG. 1.a is a partial left back side view illustrating the rear panel of a parcel shelf on the linkage of the back of the rear seats inside of a vehicle extending the trunk bed and the back of the rear seats, according to one embodiment, consistent with embodiments disclosed herein.

FIG. 1.b is a side plan view illustrating the panels of a folded parcel shelf connected by hinging, placed with one end on a linkage between the headrest and the back of a folded rear seat and with another on the rear end of the top of a center console and secured from tipping by the back of a seat of a subsequent seat row inside of a vehicle, according to one embodiment, consistent with embodiments disclosed herein.

FIG. 2.a is a partial right back side view illustrating the seat base and seat top of an unfolded rear seat, a center console and a seat of a subsequent seat row inside of a vehicle, according to one embodiment, consistent with embodiments disclosed herein.

FIG. 2.b is a partial side plan view illustrating the rear and front panels of a foldable parcel shelf in, part of the seat top of unfolded rear seats, and two seats of a subsequent seat row inside of a vehicle, according to one embodiment, consistent with embodiments disclosed herein.

FIG. 3.a is a partial right back side view illustrating a level difference between the back of the rear seats and the trunk bed inside of a vehicle, according to one embodiment, consistent with embodiments disclosed herein

FIG. 3.b is a perspective side view illustrating a container of two components, one of which having an internal volume sufficient to contain the other component of the at least two components and both having space within, according to one embodiment, consistent with embodiments disclosed herein.

FIG. 4.a is a perspective right rear top side view illustrating a folded parcel shelf connected by hinging and the two railing protrusions of the parcel shelf inside a vehicle, according to one embodiment, consistent with embodiments disclosed herein.

FIG. 4.b is a perspective right rear top side view illustrating an unfolded parcel shelf connected by hinging, and two railing protrusions inside of a vehicle, according to one embodiment, consistent with embodiments disclosed herein.

FIG. 5.a is a partial right rear top side view illustrating a central console with both its armrest positioned to the front end of their motion path and a substantially flat area at the top of the back of the central console, according to one embodiment, consistent with embodiments disclosed herein.

FIG. 5.b is a partial right rear top side view illustrating a central console with both its armrest positioned to the rear end of their motion path and a pair of drink holders at the front end of the central console, according to one embodiment, consistent with embodiments disclosed herein.

FIG. 5.c is a partial right rear top side view illustrating a central console with one of its armrests positioned to the rear end and the other to the front end of their motion path, according to one embodiment, consistent with embodiments disclosed herein.

FIG. 6.a is a partial side plan view illustrating the panels of a folded parcel shelf, placed with one end on a linkage between the headrest and the back of a folded rear seat and with another on the rear end on the top of a center console in a distance from the back of a seat of a subsequent seat row, the railing protrusions of the front panel of the parcel shelf and the substantially level extension of the back of the folded rear seat inside of a vehicle, according to one embodiment, consistent with embodiments disclosed herein.

FIG. 6.b is a partial side plan view illustrating a wedge between the two panels of a folded parcel shelf placed with one end on a linkage between the headrest and the back of a folded rear seat, with another on the top of the rear end of a center console and secured from tipping by each panels thereof and the back of a seat of a subsequent seat row inside of a vehicle, according to one embodiment, consistent with embodiments disclosed herein.

FIG. 6.c is a partial side plan view illustrating a foldable parcel shelf with the railing protrusions thereof faced up, with part of its rear panel on the back of a folded rear seat, and with part of its front panel on top of the back of a center console unsecured by a seat of a subsequent seat row or by the armrest of the center console inside of a vehicle, according to one embodiment, consistent with embodiments disclosed herein.

FIG. 6.d is a partial side plan view illustrating a wedge between the two panels of a folded parcel shelf placed with one end on a linkage between the headrest and the back of a folded rear seat, with another on the top of the rear end of a center console and secured from tipping by each panels thereof and the back of a seat of a subsequent seat row inside of a vehicle, according to one embodiment, consistent with embodiments disclosed herein.

### DETAILED DESCRIPTION

A The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of extensions of folded rear seats of vehicles into elongated flat surfaces and/or related systems and methods.

A system according to one embodiment includes a foldable parcel shelf of a vehicle. The parcel shelf comprises of two panels covered connected with at least one hinge. The at least one hinge is preventing the at least two panels from completely folding and effecting them to substantially maintain a significant distance between at least one end of the panels. The system further includes rear seats which have substantially flat backs which connect the trunk floor or floor into a substantially flat and/or level bed surface. The system further includes a central console. The central console provides support to the folded parcel shelf from one end to extending the bed surface. The system further includes at least one electronically controlled, slidable and/or reclinable seat of a subsequent seat row to secure the parcel. The system further includes a processor, and logic integrated with and/or executable by the processor. The logic is configured to determine the position of the at least one electronically controlled slidable and/or reclinable seat of the subsequent seat row as well as the tilt angle thereof. The logic is further configured to cause the at least one electronically controlled slidable and/or reclinable seat of the subsequent seat row to slide to a position and/or tilt in an angle to secure the parcel shelf in position.

In one general embodiment, A method includes folding at least one rear seat of a vehicle down. The at least one rear seat have a substantially flat back which connect the trunk floor into a substantially flat and/or level surface, hereinafter referred to as bed surface, when folded down. The method further includes the folding of a foldable parcel shelf. The parcel shelf includes at least two panels connected with at least one hinge preventing at least two the panels from completely folding and effecting them to substantially maintain a significant distance between at least one end of the panels. The method further includes folding the parcel shelf and placing it by at least one end on the back of the at least one foldable rear seat along the edge of the at least one hinge and on a center console extending the bed surface.

In another general embodiment, a computer program product according to one embodiment includes a computer readable storage medium having stored thereon computer readable program instructions configured to cause a processor of a computer system to instruct a vehicle to slide and/or tilt one or more seats to secure at least one folded parcel shelf placed on the back of the headrests of at least one foldable rear seat of a vehicle with one of its end on a center console of the vehicle on the other.

Conventional vehicles, and particularly conventional passenger vehicles, commonly implement foldable seats to provide additional functionality for extended storage of articles or sleeping people. For an owner, operator or occupant, hereinafter user, these surfaces often provide for space only sufficient to sleep a person significantly shorter than an average user that is about 5′6″. This is because the length of the bed surface is not long enough for the height of an average user.

Accordingly, for the average user to stretch their body out while lying on the bed surface is typically not possible. Moreover, even lying diagonally causes extreme discomfort for the user since lying diagonally renders a user's feet to be confined by the interior of the trunk of and/or the interior panel(s) of one side of the vehicle, in other words, effectively rendering the user to sleep within a diamond floor-mapped surface with the head in one corner and the feet in another. This can be very unpleasant, and unergonomic, and may lead to long-term, adverse effects on the health of an average user or cause injuries. Moreover, since sleeping in a vehicle often occurs during long distance travelling when other accommodations or arrangements may not be due to the distance between the user and such accommodations or the user's need for sleep, sleep poor in quality may result in subsequent accidents causing injuries or fatalities especially on roads where pulling over and resting is not feasible or permitted. Addressing this issue, users typically have to rely on using items not inherent to their vehicles leaving them with the choice of having to of use up precious and typically rather limited cargo space or risking being left without means to quality sleep on longer trips.

Various embodiments described herein include extending the bed surface with the parcel shelf typically inherent to vehicles for providing such a bed surface that is longer than the typical height of an adult male user even when lying perpendicular to the width or parallel to the length of the bed surface resulting in lying and resting of elevated comfort and higher quality for the user while saving them from having to load into and keep additional cargo within their vehicle.

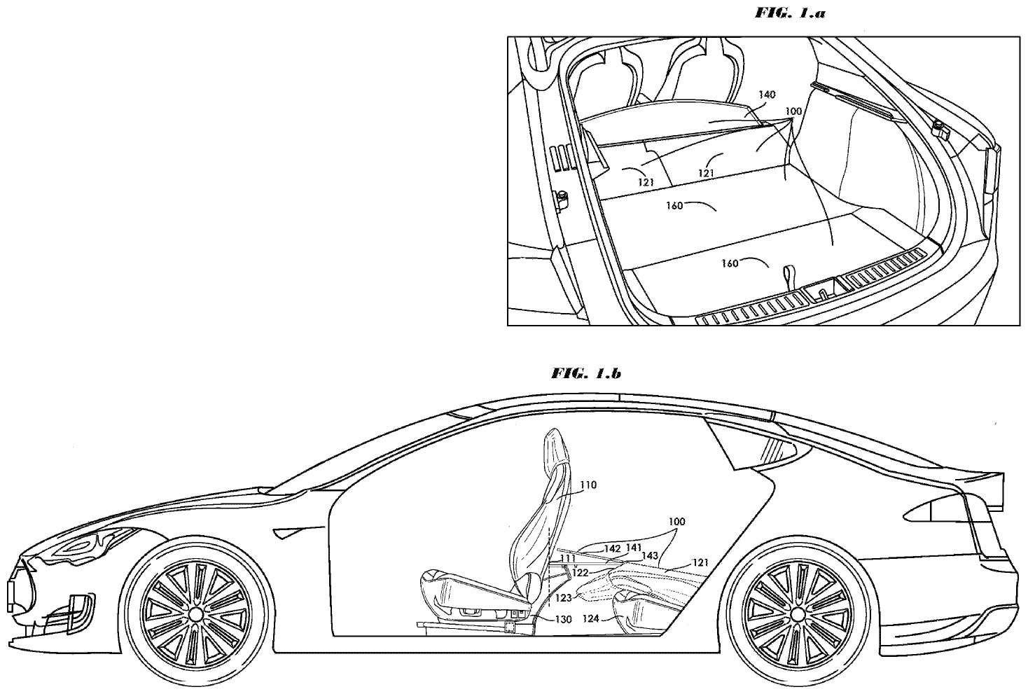

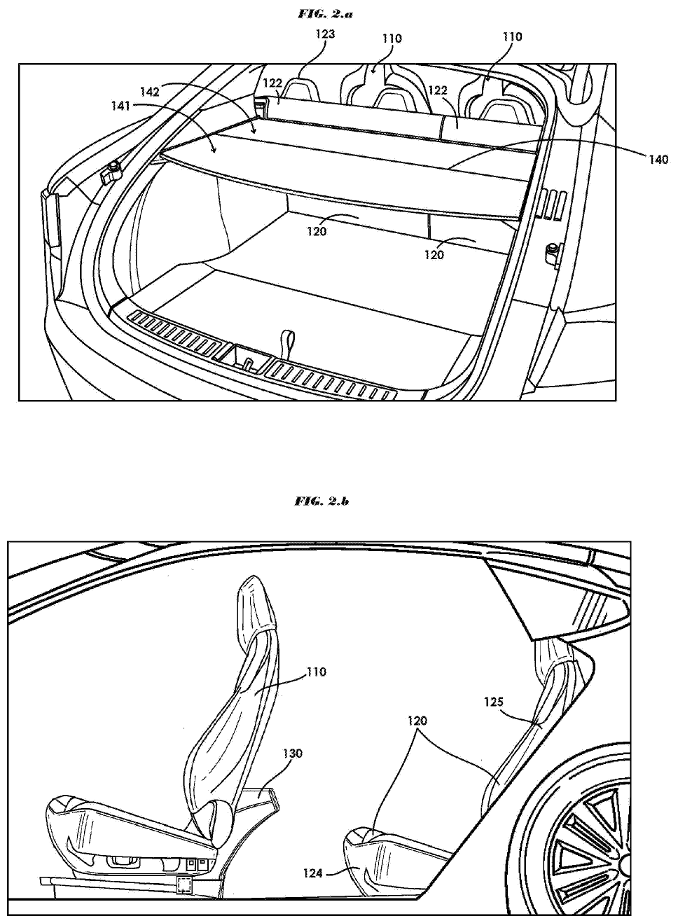

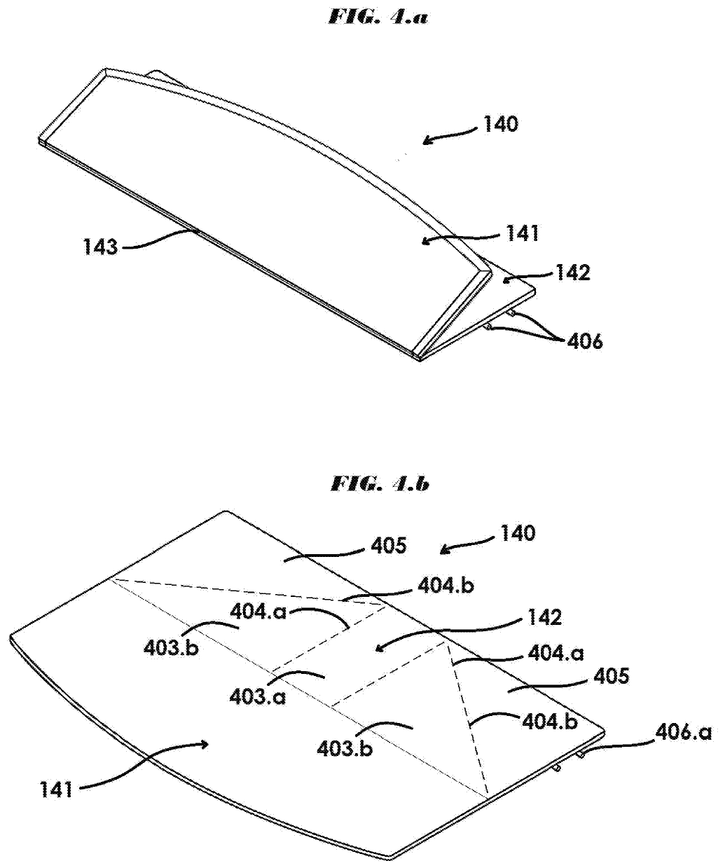

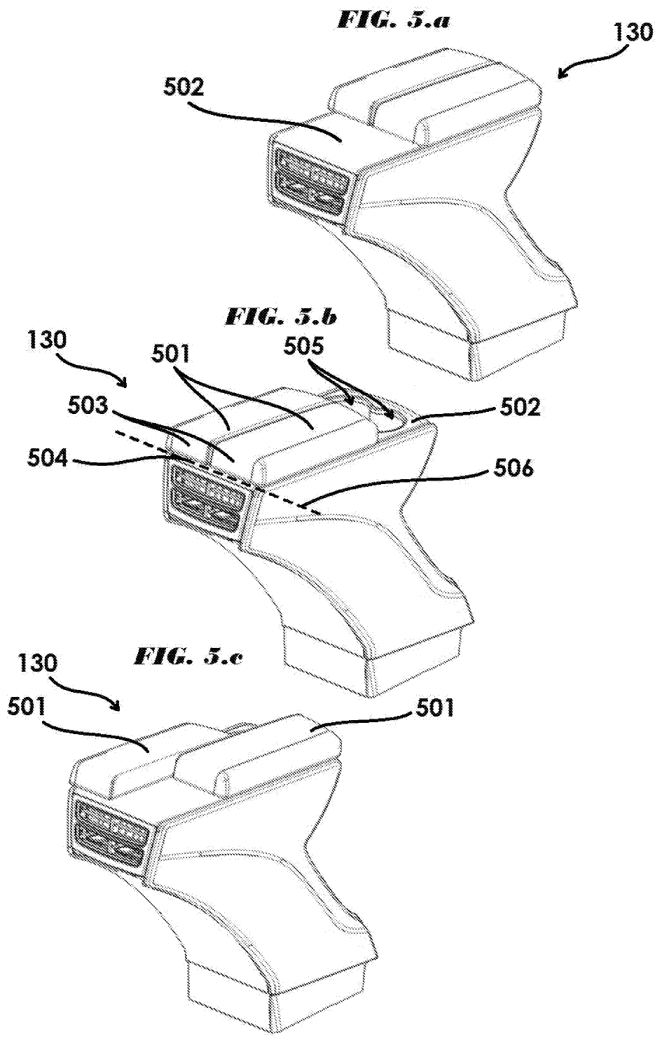

FIG. 1.a and FIG. 1.b show apparatus 100 an exemplary in-cabin convertible bed of a vehicle, according to one embodiment. The in-cabin convertible bed 100 comprises of a substantially flat and/or level surface in what typically is the rear end compartment or trunk of a vehicle (hereinafter referred to as “trunk floor”) 160; the substantially flat and/or level surface of what typically is the back of at least one seat inside the vehicle and closest to the trunk floor (hereinafter referred to as “seatback”) 121; the connected, substantially flat and/or level surface of the trunk floor 160 and the at least one seatback 121; a parcel shelf—for e.g., now referring to FIG. 2.a, that of the vehicle—140, one of the broader substantially flat and/or level surfaces of at least two panels 141 and 142; now referring to FIG. 5.a, may comprise of a central console 130, Now referring to FIG. 4.a, the parcel shelf 140 may comprise of a fabric hinge 143 connecting the at least two panels of the parcel shelf 140. The at least two panels may be shaped differently; for e.g., one 141 fitting closer and another 142 further to what typically is the rear end of a vehicle (141 and 142 hereinafter referred to as “rear panel” and “front panel” respectively). The hinge 143 may enable them to fold up. Furthermore, now referring to FIG. 1.b, the hinge 143 may keep the rear panel 141 and the front panel 142 apart substantially leveling the back surface of the at least one rear seat 121 and the rear panel 142 as present parts of the in-cabin convertible bed 100. Now referring to FIG. 5.a, the central console 130 may comprise of a substantially flat and/or level surface 502 on the top thereof. Now referring to FIG. 2.a, the rear seats may comprise a linkage 122 between the head rest 123 and the back of the rear seat 121. Now referring to FIG. 1.b, the parcel shelf 140 folded up may be placed on the surface of the linkage 122 at the at least one hinge 143. In order for the user to be provided a more reliable extension for them to lay down comfortably, the parcel shelf 140 and/or one or both of its panels may be secured relative to the vehicle, and for the user to be provided a more convenient way to quickly convert the parcel shelf 140 and the at least one rear seat 120 into an extended in-cabin convertible bed 100, the parcel shelf 140 may be secured in a position. Accordingly, at least one end of at least one of the panels of the parcel shelf 140, for e.g., at the at least one hinge 143, may be positioned on the linkage securing it against force applied on the parcel shelf 140 towards substantially the floor of a vehicle while the other end of the at least one panel of the parcel shelf 140 may be positioned on top of the substantially flat and/or level surface 502 of the central console 130. Specifically, the at least one panel of the parcel shelf 140 may be positioned on the level surface 502 of the central console 130 at, now referring to FIG. 4.b, substantially under the unhinged end of the panel 142 and on the linkage 122 at the hinge 143 under the supported areas 403.a and 403.b. Now referring to FIG. 2.b, the at least one rear seat may comprise of at least one seat base 124 and seat top 125. Now referring to FIG. 1.b, even upon weigh compressing any cushion of the at least one seat base 124 and/or seat top 125 changing the angle of the back of the rear seat 121 and, as part of the in-cabin convertible bed 100, the angle of at least part of the sleeping surface of the convertible bed 100, the angle of the linkage 122 additionally provides support against force substantially parallel to the floor of a typical vehicle in the direction of what typically is the rear end of such vehicle. Even further, the subsequent seat row 110 may provide support against force substantially parallel to the floor of a typical vehicle in the direction of what typically is the front end of such vehicle as such subsequent seat row 110 typically allow their user to adjust the inclination and/or the relative substantially horizontal position between one end and/or the other end of typical vehicles of such seats and as such allowing the back of such seats 111 to block one or both panels of the parcel shelf from moving towards what typically is the front end of vehicles. Even further, FIG. 1.b shows the subsequent seat row 110 provide support against force substantially perpendicular to the floor of a typical vehicle and directed towards the floor of such vehicle as such subsequent seat row 110 are typically configured to have an inclination beyond 90 degrees and/or allow their user to adjust the inclination of such seats toward one end and/or the other end of typical vehicles and as such allowing 111 the back of such seats to prevent, now referring to FIG. 4.b., direct or indirect force upon one or the other area 405 provided no support to from below to tip the parcel shelf 140 along the respective tipping line 404.b toward what typically is the bottom of such vehicles at one such area 405 and toward what typically is the top of such vehicles at the other such area 405. Even further, the in-cabin convertible bed 100 may comprise of a self-inflatable mattress of at least one panel or any solution or material known in the art to provide cushion covering at least part of the surface of the trunk floor 160, the back of the at least one rear seat 121, and/or the at least one panel of the parcel shelf.

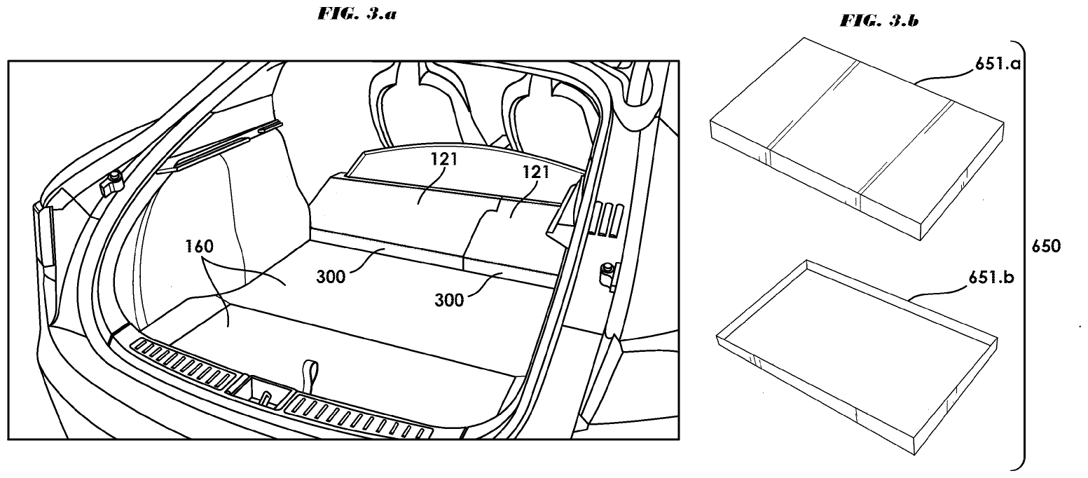

Now referring to FIG. 3.a, the connected, substantially flat and/or level surface of the trunk floor 160 and the seatback 121, occasionally, may not be level having a difference in height relative to what typically is the bottom of a vehicle typically due to the bottom area 300 of at least one seat top 125 raising above the level of the trunk floor 160 hence, now referring to FIG. 3.b, may comprise of at least one container of at least two components 350, now referring to FIG. 3.b, at least one component 351.a of the at least two components of which having an internal volume sufficient to contain at least one other component 351.b of the at least two components entirely; or any other mechanism known in the art to furnish the purpose of elevating the trunk floor 160 and/or substantially making the top of the seatback 121 level with the trunk floor 160.

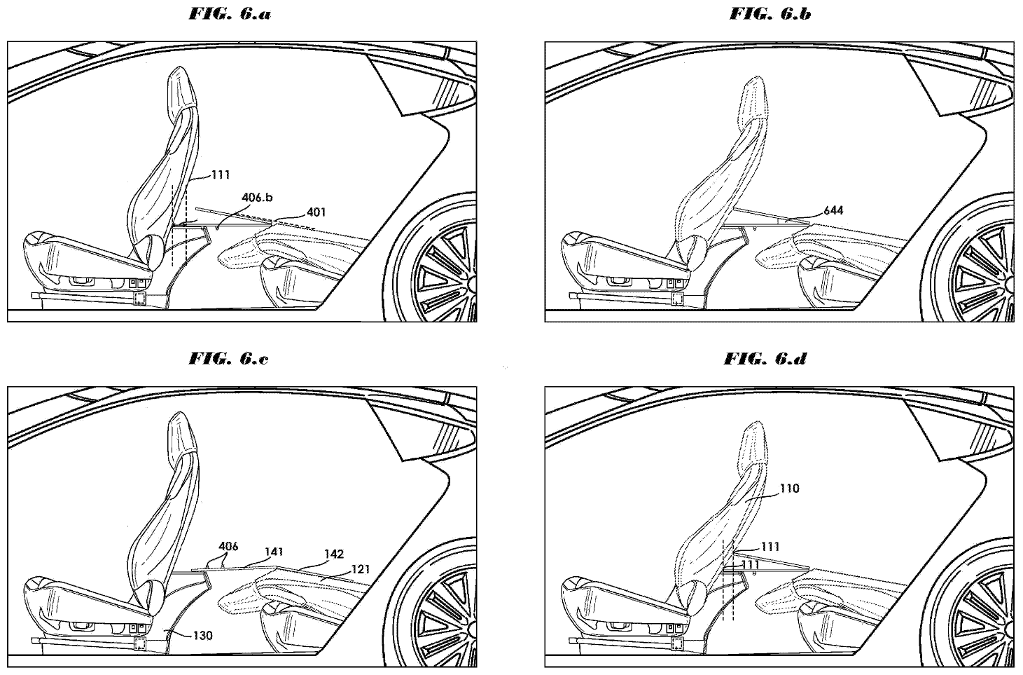

In other embodiments, referring to FIG. 6.b, to provide additional support to the front 141 and rear panel 142 to maintain their angle relative to each other under excessive weight, at least one solid, triangular wedge 644 of the desired angle of the panels, or any mechanism known in the art to furnish such purpose of maintaining the angle of the panels 140 may be used.

In other embodiments, if a foldable seat to leave more space for at least one seat 110 of the subsequent seat row, the at least one panel of the parcel shelf 140 may be the rear panel 142 being positioned on the level surface 502 of the central console 130.

In other embodiments, for e.g. to leave more space for at least one seat 110 of the subsequent seat row, the at least one panel of the parcel shelf 140 may be the rear panel 142 being positioned on the level surface 502 of the central console 130.

In other embodiments, in order for the user to lay their head on the parcel shelf 140 extending the in-cabin convertible bed 150 comfortably, cushion may be provided by using at least one wedge 144 made of softer materials such as foam or cushion mechanisms like inflatable pillows or any material or mechanism known in the art to maintain the angle of the panels 140 may be used.

In other embodiments, the at least one fabric hinge 143 may be at least one metal hinge or any mechanism known in the art to furnish such purpose of securing at least two panels to each other and limiting their motion relative to each other to substantially a radial motion of less than 360 degrees of the front 141 and the rear panel 142 of the parcel shelf 140 or folding around the at least one mechanism or folding.

In other embodiments, in order to maintain the desired angle of the front 141 and rear 142 panel of the parcel shelf 140 relative to each other while using at least one wedge 144 of cushion, the lowest angle of the triangular wedge may be higher than the desired angle in order to provide a level in-cabin convertible bed between the parcel shelf 140 and the back of the rear seats 150.

In other embodiments, now referring to FIG. 5.c, by sliding at least one armrest 501 of the central console 130 towards what typically is the back of vehicles a desired angle of the front 141 and rear 142 panel of the parcel shelf 140 relative to each other may be approximated elevating the surface providing support to the front panel 141 and/or the entirety of the parcel shelf 140 as well as tilting the angle of the rear panel 142 relative to the back of the rear seat 121 preferably leveling the parcel bed surface 150.

In some other embodiments, alternatively to or in joint with the subsequent seat row 110 providing support to the parcel shelf 140 at the point of contact with the back of such subsequent seat row 111, now referring to FIG. 4.a, at least one of the railing protrusions 406 and preferably one of such protrusions 406 of each side, and further preferably at least one of the railing protrusion closer to one of the wider edges of the parcel shelf 406.a is used to hook the front panel 141 and indirectly the entirety of the parcel shelf 140 to at least one in-car coat hook (not shown here) substantially above typically next to the top of one or more side windows in a vehicle to achieve the same stability with a rope, wire (not shown here) or any other product know in the art to serve as fastener (“fastener”) to attach by hooking to, wrapping around or by the use of any other methods known in the art to furnish the purpose of fastening such fastener by one end to the at least one protrusion 406.a and to the at least one in-car coat hook at the other.

In other embodiments, now referring to FIG. 5.b, at least one armrest 501 in the position what typically is the back of vehicles, the front panel 141—and indirectly the entirety of the parcel shelf 140—may be secured by wedging the front parcel in the gap 506 as indicated by the dashed line between the top of the central console 504 and the bottom of at least one sliding armrest 501.

In other embodiments, protrusions (not shown here) or railings carved out of or attached to the back of at least one seat of the subsequent seat row (not shown here) or any mechanism or solution known in the art may be used to secure and/or support at least one unhinged edge of the panels 140 instead of, or in joint with the central console 130.

In other embodiments with certain benefits, now referring to FIG. 3.b, the parcel shelf 140, with the side or one that may be folded together with the rear panel 142, may be positioned on top of the substantially flat and/or level surface 502 of the central console 130, with the rear panel 141 on the back of the rear seats 121 and with the front panel 141 on the top of center console 502 or on top of at least one arm rest 501 and, now referring to FIG. 5.b, secured by the rear end of at least one arm rest of the center console 503 and/or by the back of at least one seat of a subsequent seat row 111, according to one embodiment, consistent with embodiments disclosed herein.

Referring now to FIG. 3.c, in some embodiments, securing the parcel shelf 140 by tilting and/or sliding at least one seat of the subsequent seat row 110 in the desired position and/or angle may be achieved by electronically slidable and/or reclinable seats of the subsequent row (not shown here) and by at least one computer-executable instruction residing on a storage medium such as a physical (e.g., non-transitory) computer-readable medium. Details of such slidable and/or reclinable seats of the subsequent row 110 seats (e.g., fasteners, railings, electric motors, pneumatic actuators, wiring, electric supply, processors, data storages, and/or buttons, knobs or switches) are well known and are omitted for the sake of clarity. The at least one computer-executable instruction in some specific embodiments of the inventions may employ complex, object-oriented software programming concepts; the invention is not so limited and is easily adapted to employ other forms of directing the operation of a computer.

In other embodiments, securing the parcel shelf 140 in the desired position may be achieved by at least one electronically retractable armrest of the central console (not shown here) and by substantially similar by at least one computer-executable instruction residing on a storage medium such as a physical (e.g., non-transitory) computer-readable medium. Details of such retractable armrests (e.g., fasteners, railings, electric motors, pneumatic actuators, wiring, electric supply, processors, data storages, buttons, knobs, and/or switches) are well known and are omitted for the sake of clarity. The at least one computer-executable instruction in some specific embodiments of the inventions may employ complex, object-oriented software programming concepts; the invention is not so limited and is easily adapted to employ other forms of directing the operation of a computer.

It is to be noted that such computer-executable instructions may be implemented in a series of computer-executable instructions aimed comprehensively exhausting the capabilities of a vehicle to provide a quick, seamless transition from, for e.g., a transportational use case of such vehicle to a camping use case of such vehicle (hereinafter referred to as “Camp Mode”). Accordingly, in one preferred embodiment of the inventions, Camp Mode may comprise of such at least one computer-executable instruction which, before or after other instructions, may review and/or continuously monitor the state of the battery and/or other supplies of energy (e.g., gasoline, diesel, hydrogen etc.); based on the level of such energy supplies—typically at low levels—terminate Camp Mode, or at levels deemed sufficient, check and/or continuously monitor the external temperature and turn either the heating or the air conditioning system on—typically at external temperatures differing from levels deemed optimal inside the cabin of such vehicle—while typically at similar external temperatures Camp Mode may enable air circulation from between the cabin and the outside environment of such vehicles by instructing at least one electronically controlled fan (not shown here) to turn on, at least one electronically controlled window (not shown here) to roll down (typically partially), the electronically controlled automatic trunk gate to lift (not shown here) or at least one electronically controlled automatic sunroof to retract of such vehicle; additionally, Camp Mode may utilize sensors (e.g., microphones, cameras, ultrasound sensors etc.) or retrieve location-based online information via means of wireless communication (e.g., 5G, 4G, LTE, 3G, 2G, W-CDMA, CDMA, GSM, WLAN, Satellite data connection etc.) to monitor real-time precipitation and execute instructions and during active precipitation to terminate instructions to roll down the at least one electronically controlled window (not shown here), to lift the trunk gate (not shown here) or to retract at least one electronically controlled automatic sunroof of such vehicle or to instruct, with exception to the at least one electronically controlled fan, windows to roll up or close any electronically controlled automatic windows, doors, gates or sunroofs respectively.

Moreover, in some approaches, vehicles furnished with at least one accelerometer, 2-axis or 3-axis gyroscope and/or two digital levels perpendicular to each other and set up to monitor the horizontal level, (hereinafter collectively referred to as a “Level Meter”), as well as at least one adjustable suspension, Camp Mode may at least upon on each activation, request data from at least one Level Meter pertaining the relative 2-axis horizontal angle of the floor of such vehicle to water level, and adjust at least one such adjustable suspension of such vehicle to adjust the 2-axis horizontal angle of the in-cabin convertible bed to an angle either defined manually by the user or preset and residing on a storage medium such as a physical (e.g., non-transitory) computer-readable medium pertinent to the operation of Camp Mode.

Moreover, Camp Mode may comprise of a series of additional computer-executable instructions to monitor sensors (e.g., microphones, generic cameras, infrared camera, and/or ultrasound sensors etc.) to identify general motion, and by utilizing data models, differentiating between inanimate objects and sentient beings; between animals and humans; between predators exposing a threat to humans and animals of prey or predators harmless to humans in order to adjust, typically to instruct at least one electronically controlled window to roll up or close any electronically controlled automatic windows, doors, gates or sunroofs respectively.

The program environment in which one embodiment of the invention may be executed illustratively incorporates one or more general-purpose computers or special-purpose devices such as in-seat computers (not shown here), in-car computers (not shown here), or hand-held computers (not shown here). Details of such devices (e.g., processor, memory, data storage, input and output devices) are well known and are omitted for the sake of clarity.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. An apparatus in a vehicle comprising:
at least one seat base connected in a foldable fashion to a seat top with a substantially flat back;
a trunk with substantially flat floor divided from the cabin of the Consumer Vehicle by the at least one seat base and/or the seat top of the at least one seat base;
at least one panel which may serve as a parcel shelf and a substantially flat, level and/or level extension of the surface of the back of the seat top folded down;
at least one substantially vertical and/or horizontal support mechanism to support the at least one panel substantially at the at least one other edge of the panel.

2. An apparatus as recited in claim 1, wherein the at least one panel comprises of at least one additional panel connected to the at least one panel by at least one hinge mechanism.

3. An apparatus as recited in claim 2, wherein the at least one hinge mechanism, when folded, may take the substantially similar angle of the angle of the back of the seat top folded down.

4. An apparatus as recited in claim 1, wherein the substantially vertical support mechanism is a center console.

5. An apparatus as recited in claim 1, wherein the at least one panel is secured by the back of at least one seat of a subsequent seat row.

6. An apparatus as recited in claim 5, wherein the at least one seat of a subsequent seat row is slidable and/or reclinable and comprises at least one electrically controlled sliding mechanism and at least one electrically controlled reclining mechanism to automatically adjust position and/or recline.

7. An apparatus as recited in claim 1, wherein the at least one vertical support mechanism is at least one rope or similar article attached or tied to the at least one panel by at least one end and to at least one coat hook or to any other substantially similarly located interior parts of the vehicle or thereof at the at least one other end.

8. An apparatus as recited in claim 6, wherein the apparatus comprises a processor; and logic integrated with and/or executable by the processor, the logic being configured to cause the at least one electronical component to automatically adjust the position and/or recline the at least one slidable and/or reclinable seat to secure the at least one panel by the back of the at least one seat of the subsequent seat row.

9. An apparatus as recited in claim 1, wherein the trunk with substantially flat floor is elevated and/or made substantially level with the back of the at least one seat top when folded on the seat base by a container of at least two members, one member of the at least two members of which having an external volume to cover substantially at least half of the surface of the trunk floor, a height to reduce the level difference between the seat back and the seat floor to substantially at least half and an empty space inside of a volume sufficient to contain at least one other member of the at least two members of the container, and the at least one other member also having an external volume to cover at least substantially one half of the surface of the trunk floor, a height to reduce the level difference between the seat back and the seat floor to substantially at least half and a substantially similar empty space inside.

10. An apparatus as recited in claim 9, wherein the apparatus comprise at least one self-inflatable mattress of substantially a surface size of at least one side substantially similar to the combined surface size of the substantially flat floor of the trunk, the substantially flat back of the seat top, and the panel for or any other material, solution and/or mechanism to furnish the purpose of providing cushion and may be contained within the container of at least two members.

11. A method of extending the back of at least one foldable seat at the rear compartment and/or trunk of a vehicle, the method comprising:
placing at or about one end of the at least one panel, which may serve as a parcel shelf, on or about the back of the seat top of the foldable seat folded down;
placing at or about at least one other end of the at least one panel on at least one substantially vertical support mechanism, surface and/or article of the vehicle and against the back of at least one seat of a subsequent seat row.

12. A method as recited in claim 11, wherein the at least one seat of a subsequent seat row is slidable and/or reclinable; and comprising:
adjusting the position and/or angle of the back of at least one seat of the subsequent seat row to one of the points of security of the at least one other end of the at least one panel on at least one vertical support mechanism, surface and/or article.

13. A method as recited in claim 11, wherein the at least one panel comprises of at least one additional panel connected to the at least one panel by at least one hinge mechanism; and comprising:
folding the at least on panel and the at least one additional panel up around the at least one hinge mechanism before or after placing one or the other panel on the at least one vertical support mechanism, surface and/or article.

14. A method as recited in claim 11, wherein the at least one hinge mechanism, when folded, may maintain the substantially similar angle of the angle of the back of at least one foldable seat folded down; and comprising:
folding the at least one panel and the at least one additional panel up around the at least one hinge mechanism to the maximum extent before or after placing one or the other panel by at least one unhinged end on the at least one support mechanism, surface and/or article.

15. A method as recited in claim 11, wherein the at least one support mechanism is at least one center console or the back of at least one armrest of the at least one center console.

16. A method as recited in claim 11, wherein the at least one support mechanism is the top of the at least one center console and the bottom of the at least one armrest of the at least one center console; and comprising:
wedging the at least one panel between the top of the at least one center console and the bottom of the at least one armrest at the end of the at least one center console and the top of the at least one center console at the end of the at least one center console.

17. A method as recited in claim 12, wherein the at least one slidable and/or reclinable seat comprises at one electrically controlled sliding mechanism and at least one electrically controlled reclining mechanism to automatically adjust position and/or recline; and comprising:
actuating the at least one electronically controlled sliding and/or reclining mechanism to adjust the position of and/or recline the back of at least one slidable and/or reclinable seat to contact at least one other end of the at least one panel after placed on the at least one vertical support mechanism, surface and/or article.

18. A method as recited in claim 16, wherein the at least one electronical component of the at least one slidable and/or reclinable seat to automatically adjust position and/or recline comprises a processor; and logic integrated with and/or executable by the processor, the logic being configured to cause the at least one electronical component to adjust the position and/or recline the at least one slidable and/or reclinable seat to secure the at least one panel by the back of the at least one seat of the subsequent seat row; and comprising:
detecting input;
determining the position of the back of the at least one slidable and/or reclinable seat;
adjusting the position of the back of the at least one slidable and/or reclinable seat based on the determined position thereof.

19. A method as recited in claim 15, wherein the at least one panel is secured by the at least one substantially horizontal support mechanism is at least one center console and a substantially vertical support mechanism, surface and/or article is the back of the at least one armrest of the at least one center console;
and comprising:
adjusting the position of the at least one armrest of the at least one center console about, but not completely, to the rear end of the at least one center console.

20. A method as recited in claim 1, wherein the at least one support mechanism comprises at least one rope or similar article and at least one coat hook or any at least one other substantially similarly located and functioning interior part of the vehicle, and comprising:
attaching or tying the at least one rope or similar article to the at least one panel by at least one end;
attaching the at least one other end of the at least one rope or similar article to the at least one coat hook or any at least one other substantially similar and similarly located and functioning interior part of the vehicle.
